(19) United States
(12) Patent Application Publication
(10) Pub. No.: US 2026/0267887 A1
(43) Pub. Date: Sep. 10, 2026

(54) Adaptive Hybrid Ai + Ni Orchestration System With Model Stacking And Fine-Tuning

(71) Applicant: Michael Burtov, North Miami Beach, FL (US)

(72) Inventor: Michael Burtov, North Miami Beach, FL (US)

(21) Appl. No.: 19/073,882

(22) Filed: Mar. 7, 2025

(51) Int. Cl. G06F 16/334; G06F 11/34; G06F 16/34; G06F 21/62

(52) U.S. Cl. CPC G06F 16/334; G06F 11/3409; G06F 16/345; G06F 21/62

(57) ABSTRACT

The present invention relates to an adaptive hybrid AI+NI orchestration system that enhances the flexibility, efficiency and security of multi-provider AI workflows. By integrating model stacking and fine-tuning, the system allows for dynamic selection of specialized AI services based on real-time conditions. The orchestration layer along with a performance metric repository is configured to continuously evaluate and improve the selection of AI providers. The inclusion of a natural intelligence (NI) fine-tuning module personalizes AI outputs by incorporating user inputs. Additionally, a security and compliance module enforces encryption, access controls and compliance logging to ensure the safe handling of sensitive data. Real-time customization is facilitated by uploading fine-tuning documents, which allow the system to dynamically adapt to user needs and environmental factors. The invention offers cost-efficiency, personalized service and secures data management, making it ideal for applications requiring high-performance AI workflows in regulated environments.

### TECHNICAL FIELD

The invention relates to the field of multi-model, multi-provider Artificial Intelligence (AI) orchestration and more specifically to an adaptive hybrid AI+NI (Natural Intelligence) orchestration system. The system efficiently manages tasks across various AI services while integrating human-driven inputs including AI fine-tuning documents, real-time sensor data and user feedback.

### BACKGROUND

The background description includes information that may be useful in understanding the present invention. It is not an admission that any of the information provided herein is prior art or relevant to the presently claimed invention, or that any publication specifically or implicitly referenced is prior art.

Traditionally, Artificial Intelligence (AI) architectures have been primarily relied on a single AI model or a small set of static models from a single service provider to handle a wide range of tasks. The monolithic AI solutions were configured to provide general-purpose capabilities such as text generation, image creation or data analysis, but as the demands of users became more specialized, the limitations of the traditional systems became evident. For instance, businesses may need to generate marketing copy that not only conveys the right message but also adheres to strict brand guidelines, legal content that complies with specific regulations or technical documentation that requires domain-specific knowledge. Standard AI systems are not equipped to handle such diverse and specialized tasks effectively. They tend to offer an approach that falls short of delivering the high level of customization and quality that modern users, especially businesses require. The system are typically inflexible and struggle to adapt to various domains like text creation, image generation, software development or data analytics, leaving a gap between user expectations and AI capabilities.

One of the major drawbacks of traditional AI systems is the lack of real-time adaptability. In many cases, AI providers allow only limited fine-tuning which usually involves a one-time static process. The fine-tuning is often based on a narrow set of parameters with little room for ongoing adjustments to accommodate evolving user needs. This becomes especially problematic when users require tailored outputs that reflect specific organizational constraints such as brand language, industry-specific jargon, compliance regulations or evolving market conditions. In such scenarios, AI models that lack dynamic fine-tuning capability can produce generic results that do not meet the user's or organization's needs, reducing both the relevance and accuracy of the AI's outputs. The inability to continuously adjust AI responses in real-time for the highly specialized requirements compromises user satisfaction and the overall effectiveness of AI systems in meeting critical business needs.

Another significant limitation of conventional AI solutions is the inability to switch seamlessly between multiple AI service providers during a single workflow. For instance, if a user starts a task such as drafting a marketing pitch with one AI provider, but later needs to create a sophisticated image or generate code for a website, the system generally cannot transition smoothly between different providers that specialize in those areas. The lack of orchestration across multiple AI services results in fragmented workflows. Users are forced to manually migrate content from one platform to another which not only wastes time but also leads to inefficiencies and potential inconsistencies in the final output. Furthermore, the need for manual intervention adds complexity to the workflow increasing operational costs and often diminishes the overall user experience. The issue is particularly evident in more complex tasks that require input from multiple specialized AI providers as users must navigate between different tools, further hindering productivity and increasing the chances for errors or mismatched results.

Moreover, traditional AI systems typically do not allow users to upload custom fine-tuning documents alongside their prompts. The absence of a real-time customization mechanism severely restricts users' ability to incorporate domain-specific knowledge, legal requirements or personal creative styles when using AI. Users cannot specify unique guidelines or specialized constraints for each prompt, limiting the AI's ability to generate highly personalized, relevant and compliant outputs. The inability to directly share detailed instructions or industry-specific rules with the AI in real-time makes it difficult for the system to adapt to individual needs or organizational standards. The lack of dynamic fine-tuning further leads to the issue of limited flexibility and impedes the potential of AI to deliver tailored, high-quality outputs in specialized fields such as law, healthcare, marketing and technology.

U.S. Pat. No. 11,423,901B2 discloses a dialog management system that utilizes multiple AI service providers to handle user queries. The system when receives a query then a dispatcher bot selects a worker bot based on query history which is associated with a specific AI service provider. The system can evaluate the performance (efficiency, speed, quality, accuracy) and cost of different providers allowing it to switch between them dynamically. An AI service provider's cost if increases or performance decreases, the system can automatically switch to a more efficient provider. The system generates and outputs the response based on the selected provider's representation.

CN117234738B discloses a blockchain system integrated with an artificial intelligence (AI) model and an intelligent contract processing method. The system includes a request receiving module that handles service requests, a task scheduling engine that identifies the AI model needed and a model management module that selects the appropriate AI model based on the request. The task scheduling engine then chooses the AI provider and forwards the service request for processing. The system enhances processing efficiency by automatically matching intelligent contract requests with suitable AI processing parties.

Conventionally, there exist several systems that use different AI models to execute a specific task; still there is pressing need for a solution that enables dynamic switching between multiple AI providers, real-time fine-tuning and the integration of personalized, domain-specific knowledge. The solution should ensure that AI outputs are not only accurate and relevant but also compliant with regulatory standards, aligned with brand guidelines and able to adapt to changing market conditions.

### SUMMARY

The present invention relates to an adaptive hybrid AI+NI orchestration system that offers significant advantages in task optimization, customization and efficiency. The system dynamically orchestrates tasks across multiple AI providers by evaluating sub-tasks (e.g., text drafting, image generation, coding, data analysis) and route them to the most suitable AI service. This ensures optimal performance is achieved based on the unique strengths of each provider. The system further supports mid-session provider switching, allowing users to transition between AI engines seamlessly while maintaining contextual consistency, enhancing flexibility and user experience. Additionally, the real-time fine-tuning capability enables the uploading of specialized documents (e.g., brand guidelines, compliance parameters) to customize AI outputs to the specific needs of individuals or organizations. By integrating multiple AI services, human intelligence and real-time feedback, the system delivers a highly scalable, secure and future-proof solution. The invention has broad applicability in diverse industries, enabling efficient and personalized task management, while adapting to the evolving demands of both personal and enterprise-level requirements. The invention addresses existing AI limitations, offering a customizable, secure and adaptable framework that ensures continuous improvement and growth.

In an embodiment of the present invention, the invention discloses an adaptive hybrid AI+NI orchestration system with model stacking and fine-tuning. The system comprises an orchestration layer configured to manage high-level decision-making for multi-provider AI model stacking; an AI provider library configured to house multiple specialized AI services which are selected by the orchestration layer based on real-time conditions; a performance metric repository configured to continuously log and evaluates the performance of each AI provider. Further, the system includes a natural intelligence (NI) fine-tuning module configured to ingest natural intelligence inputs and merge them with user prompts to generate personalized AI outputs. In addition, a security and compliance module is configured to enforce encryption, access controls and compliance logging for secure handling of user prompts, fine-tuning documents and AI outputs. Moreover, the system enables real-time customization by uploading a fine-tuning document with each prompt to ensure compliance with user needs and dynamically adapts AI service selection and data processing based on real-time data and sensor data.

In one of the embodiments of the present invention, the orchestration layer continuously updates the performance metric repository based on user feedback or ratings provided after each sub-task is completed, thereby refining future AI provider selection.

In one of the embodiments of the present invention, a sensor interface is connected to the orchestration layer to receive real-time data including environmental, biometric and operational data, enabling the orchestration layer to adjust AI outputs accordingly.

In one of the embodiments of the present invention, the NI fine-tuning module is configured to automatically summarize or extract relevant portions of the fine-tuning document based on the context of the user prompt, thereby minimizing data overload for each AI provider.

In one of the embodiments of the present invention, the orchestration layer performs mid-workflow switching from a first AI provider to a second AI provider based on conditions such as task change, cost optimization threshold, user preference for a specific AI model or latency threshold.

In one of the embodiments of the present invention, the security and compliance module include encryption at rest and in transit using an industry-standard cryptographic algorithm, role-based access controls for limiting editing of fine-tuning document and audit logging for regulatory compliance.

In one of the embodiments of the present invention, the system includes a cost optimization engine configured to compare AI provider costs with sub-task accuracy requirements and automatically switch to a more cost-effective provider when criticality falls below a threshold.

In one of the embodiments of the present invention, the AI provider library houses a variety of specialized AI services including ChatGPT, Anthropic, Gemini, Flux etc.

In one of the embodiments of the present invention, the system integrates real-time sensor data from physical or virtual sensors such as IoT devices, biometric wearables or environmental monitors to adapt AI-generated outputs based on environmental conditions, user behaviour or physiological responses.

In one of the embodiments of the present invention, the natural intelligence inputs include brand guidelines, style preferences, domain constraints and sensor data.

In another embodiment of the present invention, the invention discloses an adaptive hybrid AI+NI orchestration method with model stacking and fine-tuning. The method comprising receiving a user prompt by an orchestration layer that includes a request requiring the decomposition of the task into multiple sub-task, decomposing the user prompt into multiple sub-tasks based on domain-specific or task-specific criteria; accessing a performance metric repository through the orchestration layer by storing metrics for each AI provider and selecting an AI provider for each sub-task from a plurality of AI providers based on the performance metrics and task requirements. The method also includes receiving a fine-tuning document uploaded by a user which encodes brand guidelines, stylistic preferences, compliance requirements or proprietary knowledge; applying the fine-tuning document to the selected AI provider and executing each sub-task to generate an output consistent with the fine-tuning document. In addition, the method performs delivering of integrated result by combining the outputs from each subtask.

In one of the embodiments of the present invention, the fine-tuning document includes sensor data from IoT devices or wearables that influence the context in which each AI provider performs the sub-tasks.

In one of the embodiments of the present invention, the compliance rules embedded within the fine-tuning document are used to filter or mask sensitive user data before transmission to selected AI providers, thereby ensuring regulatory adherence.

In one of the embodiments of the present invention, the performance metrics for each AI provider include at least one of cost, response time; output quality or user feedback ratings.

In one of the embodiments of the present invention, the method further comprises collection of user feedback after executing a sub-task, updating the performance metrics and reselecting an AI provider for subsequent sub-tasks based on the updated metrics.

In another embodiment of the present invention, a non-transitory computer-readable medium storing instructions that when executed by one or more processors, cause an orchestration system to perform a method of adaptive AI orchestration. The method comprising the steps of receiving a user prompt and a fine-tuning document through a user upload interface, validating the fine-tuning document by checking for domain rule conflicts, embedding context from the fine-tuning document into a form readable by AI providers, routing the request to an appropriate AI provider based on performance metrics and task requirements, generating or refining output according to the user's constraints; and dynamically switching AI providers for new tasks and maintaining context by reapplying fine-tuning data.

In one of the embodiments of the present invention, the method further comprises encrypting all data at rest using industry-standard encryption algorithms to ensure confidentiality.

In one of the embodiments of the present invention, the instructions cause the system to automatically generate condensed summaries from large fine-tuning documents thus, selecting only relevant sections for each sub-task based on sub-task domain parameters.

In one of the embodiments of the present invention, the system utilizes block chain-based audit logging, storing records of each AI provider invocation and sub-task result in a tamper-evident ledger.

In one of the embodiments of the present invention, the system enables real-time user overrides of AI outputs, incorporating natural intelligence inputs to refine or correct results before final compilation.

For further clarification of the features and other embodiments of the invention, a more particular description is provided that will further explain the features and advantage of the invention with the illustration or the drawings. As will be appreciated, other embodiments of the present invention are possible utilizing, alone or in combination, one or more of the features set forth above or described in detail below.

### BRIEF DESCRIPTION OF THE DRAWINGS

A full understanding of the invention can be gained from the following description of the preferred embodiments when read in conjunction with the accompanying drawings in which:

FIG. 1 illustrates a block diagram of an adaptive hybrid AI+NI orchestration system, in according to embodiments of the present invention disclosed herein.

FIG. 2 illustrates a method flow of receiving a user's high-level request to generating multiple specialized outputs, in according to embodiments of the present invention disclosed herein.

FIG. 3 illustrates a block diagram of mid-interaction provider switching, in according to embodiments of the present invention disclosed herein.

FIG. 4 illustrates a block diagram of a NI fine-tuning data schema, outlining how data categories are structured and made accessible to AI providers, in according to embodiments of the present invention disclosed herein.

FIG. 5 illustrates a process flow showcasing sensor data integration with the user request using orchestration layer, in according to embodiments of the present invention disclosed herein.

FIG. 6 illustrates a process flow of uploading AI Fine-Tuning document, in according to embodiments of the present invention disclosed herein.

FIG. 7 illustrates a process flow of creation of fine-tuning document, in according to embodiments of the present invention disclosed herein.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

References will now be made in detail to the presently preferred embodiments of the invention, examples of which are illustrated in the accompanying drawings. Throughout the following detailed description, the same reference numerals refer to the same elements in all figures.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and it is not intended to be limiting the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the following description, reference will be made to the accompanying drawing, in which comparable functional elements are designated with like numerals. The aforementioned accompanying drawings show by way of illustration and not by the way of limitation, specific aspects and implementations consistent with principles of this disclosure. These implementations are described in sufficient detail to enable those skilled in the art to practice the disclosure and it is to be understood that other implementations may be utilized, and that structural changes and/or substitutions of various elements may be made without departing from the scope and spirit of this disclosure. The following detailed description is, therefore, not to be construed in limited sense. It is noted that description herein is not intended as an extensive overview, and as such, concepts may be simplified in the interests of clarity and brevity. All documents mentioned in this application are hereby incorporated by reference in their entirety.

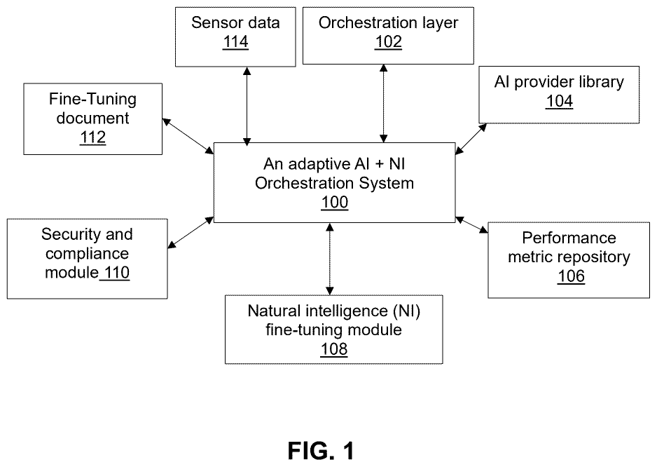

According to the embodiment of the present invention, an adaptive hybrid AI+NI orchestration system 100 is disclosed in FIG. 1 which is configured to dynamically manage multi-provider AI service models, integrate Natural Intelligence (NI) inputs and incorporate real-time data for personalized, highly efficient AI outputs. The adaptive hybrid AI+NI orchestration system 100 comprises an orchestration layer 102 which serves as the central control unit for managing high-level decision-making in multi-provider AI model stacking. The orchestration layer 102 is responsible for managing high-level decision-making by selecting AI providers and overseeing multi-provider AI model stacking. The layer 102 routes requests to the most appropriate AI models based on a variety of conditions including the specific task requirements, user preferences and the AI provider's historical performance. By continuously analyzing performance data, the orchestration layer 102 enables real-time adjustments to AI provider selection, ensuring that the most efficient and cost-effective solutions are employed at any given time. The decision-making process is facilitated by specific algorithms that evaluate real-time performance metrics such as accuracy, speed, and cost-effectiveness. The metrics help the orchestration layer to choose the best AI model for each sub-task. The orchestration layer 102 interacts with AI providers through standardized APIs and structured data formats such as JSON, ensuring seamless communication and efficient processing of requests. For example, when the orchestration layer 102 routes a task for text generation, it sends a JSON payload to the selected AI provider specifying the parameters such as tone, style, and audience. In real-time, the orchestration layer 102 dynamically adjusts AI provider selection based on performance changes or new data inputs such as real-time sensor feedback or updated user preferences, ensuring that the most appropriate and efficient AI model is always chosen. This adaptive switching between AI providers allows the system to handle a wide range of tasks efficiently, ensuring the best possible outcome based on the specific needs of the user. In an example scenario, when tasked with creating a marketing campaign, the orchestration layer 102 breaks the task into sub-tasks such as content generation, real-time data integration and brand alignment. The layer 102 dynamically routes each sub-task to the most suitable AI provider, ensuring that content is generated based on brand guidelines, adjusted for real-time sensor data and consistent with the user's specifications. The seamless orchestration powered by real-time performance evaluations and intelligent decision-making optimizes the use of multiple AI providers to deliver highly efficient and personalized outputs. In the embodiment, the system 100 houses an AI Provider Library 104 that consists of multiple specialized AI models (e.g., ChatGPT, Anthropic, Gemini, Flux, etc.) each optimized for specific tasks such as text generation, image creation, coding and data analysis The AI models are selected dynamically based on the nature of the sub-task with the orchestration layer 102 ensuring that each sub-task is routed to the most appropriate AI provider based on their performance metrics. The metrics are continuously logged and evaluated in a performance metric repository 106 which tracks various attributes such as accuracy, speed, cost per request and domain expertise. The metrics are evaluated in real time to guide the orchestration layer's 102 decision-making, ensuring that the system 100 selects the most efficient and capable AI provider available based on current conditions and historical data. If user feedback or new data becomes available, the performance metrics are updated to further refine the selection process. In the embodiment, a natural intelligence (NI) fine-tuning module 108 is another critical component of the system 100. The module 108 processes user-uploaded fine-tuning documents which include a wide range of inputs such as brand guidelines, stylistic preferences, domain-specific terminology, compliance requirements and sensor data. The inputs are used to generate personalized AI outputs that align with the user's needs. By automatically parsing and integrating the fine-tuning documents, the system 100 ensures that the generated outputs are customized to the user's or organizations specific requirements. Furthermore, the NI fine-tuning module 108 is configured to minimize data overload by extracting only the relevant portions of the fine-tuning document based on the context of the user prompt. In addition, a security and compliance module 110 enforces a robust framework for securing user data. The module 110 incorporates industry-standard encryption algorithms to protect data both at rest and in transit. Additionally, the system employs role-based access controls to restrict editing permissions for sensitive fine-tuning documents 112 and ensures that every interaction with the system 100 is logged for regulatory compliance. The system 100 is configured to comply with various industry-specific regulations such as GDPR and HIPAA, making it suitable for use in highly regulated industries like healthcare and finance. In the embodiment, the system 100 includes a sensor interface which connects to real-time sensor data 114 sources such as IoT devices, biometric wearables or environmental monitors. The real-time data 114 allows the system 100 to adjust the AI-generated outputs based on physical, environmental or user behavioural conditions. For example, in a marketing scenario, the system could adjust content generation based on real-time foot traffic data or in a healthcare application; the AI could modify its outputs based on biometric data such as a user's stress levels.

In one of the embodiments of the present invention, the NI fine-tuning module is configured to automatically summarize or extract relevant portions of the fine-tuning document based on the context of the user prompt, thereby minimizing data overload for each AI provider.

In one of the embodiments of the present invention, the orchestration layer performs mid-workflow switching from a first AI provider to a second AI provider based on conditions such as task change, cost optimization threshold, user preference for a specific AI model or latency threshold.

In one of the embodiments of the present invention, the system includes a cost optimization engine configured to compare AI provider costs with sub-task accuracy requirements and automatically switch to a more cost-effective provider when criticality falls below a threshold.

In one of the embodiments of the present invention, the orchestration system addresses the challenges of excessive latency in multi-provider calls and ensures continuity when switching between providers. In an exemplary scenario, consider the creation of a personalized marketing campaign that integrates real-time sensor data, brand guidelines and customer insights. The orchestration system begins by evaluating the task requirements and selecting the appropriate AI models. For instance, a language model like ChatGPT is chosen to generate content based on the brand's style guidelines, while a specialized data processing AI such as Flux is selected for analysing real-time sensor data such as foot traffic or customer engagement metrics. The orchestration layer manages the seamless switching between the models by utilizing optimized APIs and decision algorithms (i.e. task-specific prioritization algorithm, performance-based selection algorithm, real-time feedback adjustment algorithm, contextual data continuity algorithm etc) ensuring minimal latency and preventing delays in task execution. By storing context-aware data, the system ensures that each task maintains continuity, preserving brand tone and objectives when switching between models. This avoids the risk of losing context, ensuring a cohesive output. The orchestration system not only reduces task-switching latency but also improves efficiency by selecting the most appropriate AI model for each sub-task based on real-time performance metrics. The result is a highly accurate and personalized marketing campaign created faster and with fewer resources thus, highlighting the system's technical ability to overcome challenges such as excessive latency, loss of continuity and the need for optimized task management.

In one of the embodiments of the present invention, the invention addresses the challenge of real-time AI provider switching and sensor data integration through a novel architecture (i.e. orchestration system) that incorporates dynamic task routing, optimized data structures and specialized workflows. The orchestration layer manages AI model selection by evaluating real-time performance metrics (i.e. accuracy, speed, and cost) and routes tasks to the most suitable AI provider using standardized APIs and structured formats like JSON. Real-time sensor data from sources such as IoT devices adjusts outputs based on environmental conditions or user behaviour. The system also efficiently stores and processes business inputs like brand guidelines and compliance requirements, ensuring continuity across tasks. By optimizing resource allocation and minimizing latency, the architecture/system provides a technical solution for personalized, efficient, and context-aware AI outputs across diverse applications.

In one of the embodiments of the present invention, the system integrates multiple layers of security and compliance to protect data and ensure regulatory adherence. Data is encrypted both at rest and in transit using AES-256 encryption or at rest using AES-256 and in transit using TLS/SSL channels, ensuring that sensitive information remains protected throughout the entire process. To manage partial data exposure, the system employs strict data masking protocols limiting the access of specific information to AI providers based on the task. Compliance constraint such as GDPR and HIPAA are enforced in code by validating data inputs against the regulations before they are processed. Further, role-based access control (RBAC) ensures that only authorized personnel can interact with sensitive data or modify documents while token-based authentication adds another layer of security by verifying user identities. Layered encryption keys provide an additional safeguard for highly sensitive data. To track all interactions, the system employs block chain-based audit logs offering a transparent and immutable record of every action for real-time monitoring and regulatory compliance.

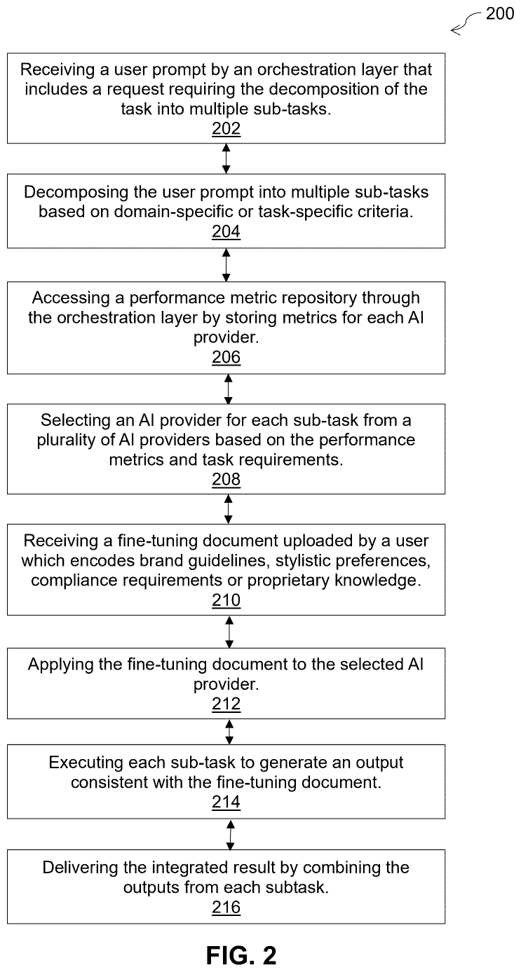

In another embodiment of the present invention, an adaptive hybrid AI+NI orchestration method 200 with model stacking and fine-tuning is disclosed in FIG. 2. In the embodiment, the step 202 discloses the method 200 where a user provides a high-level prompt which is received by the orchestration layer. The prompt typically includes a request for a task that is too complex to be completed by a single AI provider. In the embodiment, the step 204 discloses the orchestration layer acting as the central management unit to parse the prompt and decompose them into multiple sub-tasks based on domain-specific or task-specific criteria. For instance, a request to create a marketing brochure might be divided into sub-tasks such as writing the content, designing the visuals and creating the web page. By decomposing the task in this manner, the system ensures that each sub-task can be managed independently, with the correct resources allocated for its execution. In addition, according to step 206, once the sub-tasks have been identified the orchestration layer accesses a performance metric repository that stores detailed information about various AI providers. The metrics may include factors such as cost, response time, output quality and user feedback ratings. In the embodiment, according to the step 208, by referencing the metrics the system selects the most appropriate AI provider for each sub-task. The selection process is configured to match the specific requirements of each sub-task with the capabilities of the AI providers. For example, if one AI provider is known for its fast response time but another excels at generating high-quality text, the orchestration layer will choose the most suitable provider based on the sub-task's needs. In parallel, according to step 210, the method 200 allows for the inclusion of a fine-tuning document which can be uploaded by the user. The document encodes important contextual information such as brand guidelines, stylistic preferences, compliance requirements, and proprietary knowledge. The fine-tuning document ensures that the output generated by each AI provider aligns with the user's expectations including maintaining the appropriate tone, style, and adherence to regulatory standards. In the embodiment, the step 212 discloses the orchestration layer applying the fine-tuning document to each selected AI provider, ensuring that their outputs are customized according to the user's preferences. Further, according to the step 214, when each sub-task is executed, the fine-tuned AI provider generates output that is consistent with the fine-tuning document. For instance, if the fine-tuning document includes compliance rules, the rules are enforced to filter or mask sensitive user data before it is transmitted to the selected AI providers. This ensures that the outputs are not only personalized but also comply with regulatory requirements such as data protection laws. Moreover, the fine-tuning document may also include sensor data from Internet of Things (IoT) devices or wearables that influence the context in which each AI provider performs its sub-task. For example, if an IoT sensor detects a change in environmental conditions the data can be used to adjust the tone or style of generated content in real time, providing a more contextually aware output. The system's flexibility is further enhanced through Provider Switching. During the execution of the sub-tasks, if the orchestration layer identifies that a different AI provider is better suited for a subsequent part of the task, it can switch from one provider to another. The dynamic switching allows the method to adapt to changing requirements and ensure that the right AI capabilities are always utilized. For example, if the first sub-task is focused on generating textual content but the next phase involves creating complex graphics, the system can seamlessly switch to an AI provider specialized in visual content generation. Further, in step 216, once all of the sub-tasks are completed, the method 200 moves to the final step i.e. combined output. The outputs from each sub-task which could include text, images, code or other content, are integrated into a cohesive final deliverable. The orchestration layer collates and synthesizes the individual results to create a unified, comprehensive output that meets the user's original request. This ensures that the final product is not only consistent in terms of style, tone, and quality but also delivers the combined functionality of each sub-task.

In one of the embodiments of the present invention, the method further comprises collection of user feedback after executing a sub-task, updating the performance metrics and reselecting an AI provider for subsequent sub-tasks based on the updated metrics.

In one of the embodiments of the present invention, the system integrates natural intelligence (NI) inputs by continuously processing user-uploaded documents such as brand guidelines, stylistic preferences and sensor data into AI outputs. The inputs are parsed and stored in structured formats, ensuring immediate accessibility. Real-time data from sources like IoT devices is continuously monitored and factored into the AI's decision-making. If necessary, the system can immediately override AI-generated content to align with brand guidelines or user preferences. The orchestration layer ensures that the NI inputs dynamically influence AI tasks, enabling seamless integration for personalized outputs that are continuously updated based on real-time conditions.

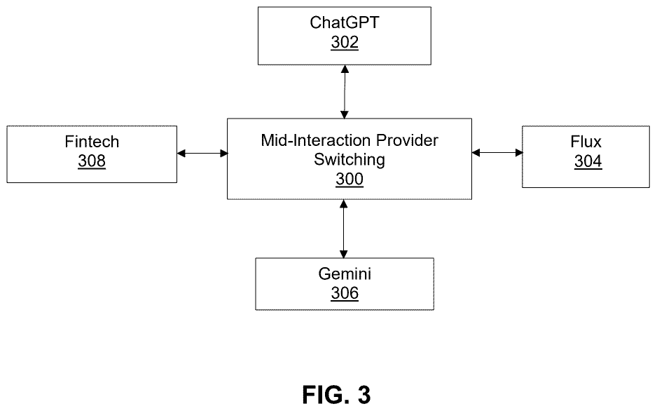

In another embodiment of the present invention, FIG. 3 illustrates the process of Mid-Interaction Provider Switching 300. The process demonstrates how the system can seamlessly transition between different AI providers during the execution of a user's task, adapting to the changing requirements of each sub-task. The user's high-level request in this example includes generating marketing materials specifically marketing copy, product images, a coded landing page and an invoice with a payment link. The workflow begins with ChatGPT 302 being invoked to generate the marketing copy as the tool excels in natural language processing and creativity. Once the text content is complete, the system identifies the need for product images and switches to Flux 304, a provider specializing in image creation. Flux 304 generates high-quality product images that adhere to the brand's guidelines such as color schemes and design preferences. As the user's request shifts to web development, the system invokes Gemini 306, an AI provider skilled in creating responsive landing page code. Gemini 306 generates the HTML, CSS, and JavaScript necessary to integrate the text and images into a functional landing page. Finally, when the user requests the generation of an invoice with a payment link, the system switches to a FinTech Provider 308 that specializes in secure financial tasks, ensuring that the invoice is accurate and compliant with financial regulations. Throughout the entire process, the system continually applies the NI fine-tuning document which includes brand guidelines, stylistic preferences, and compliance rules. This ensures that no matter which provider is invoked, the outputs remain consistent with the user's requirements. The seamless switching between providers ensures that each part of the task is handled by the most suitable provider, while the fine-tuning document ensures that all outputs are coherent and aligned with the user's specific guidelines and regulatory needs.

In one of the embodiments of the present invention, the system dynamically switches AI providers for each task, ensuring consistency through the reapplication of the NI Fine-Tuning Document.

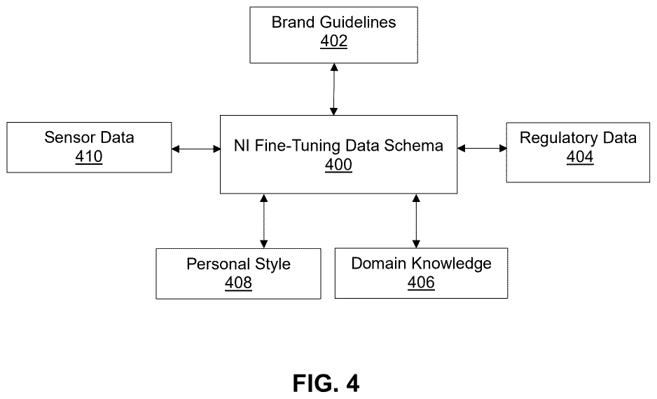

In another embodiment of the present invention, FIG. 4 discloses a NI fine-tuning data schema 400 which outlines how various data categories including brand guidelines 402, regulatory data 404, domain knowledge 406, personal style 408 and sensor data 410 are structured and made available to AI providers. The data elements are organized into distinct sections such as brand guidelines 402 (e.g., name, slogan, style guide, color palette), regulatory data 404 (e.g., HIPAA compliance, GDPR constraints), domain knowledge 406 (e.g., industry-specific jargon, technical specifications), personal style 408 (e.g., formality level, tone, language preferences) and sensor data 410 (e.g., IoT readings, biometric signals, location data). The data is encoded in structured formats like JSON or XML and is parsed into key-value pairs or tokens which are embedded into the selected AI providers as contextual information. The Fine-Tuning Document ensures that each AI provider consistently adheres to the brand, compliance, technical and style guidelines, thereby maintaining coherence across tasks and interactions.

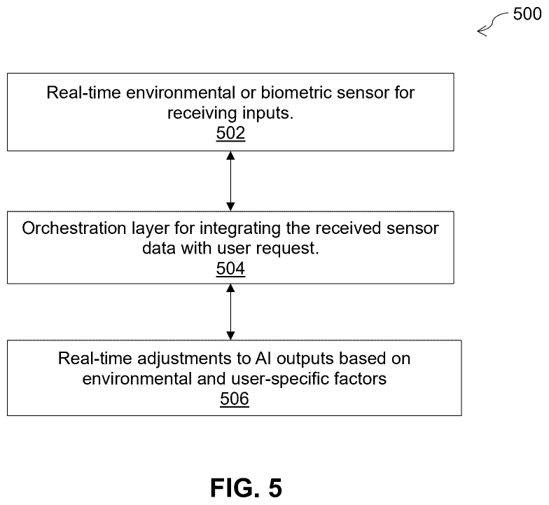

In another embodiment of the present invention, FIG. 5 illustrates the integration of sensor data 500 into the orchestration layer for enhancing the contextual awareness of the system. In the embodiment, according to step 502, real-time environmental or biometric sensor inputs such as IoT devices (e.g., foot traffic, temperature sensors) or wearable devices (e.g., stress level indicators) are continuously monitored. In the embodiment, the step 504 discloses the inputs to be fed into the orchestration layer which is configured to integrate the sensor data with the user's request thus, ensuring that AI outputs are informed by real-time conditions or user states. Further, the step 506 discloses that if a wearable sensor detects elevated stress levels, the system might adjust the tone of the output to a more soothing or simplified style. Similarly, if foot traffic data shows a surge, the system could suggest more urgent or compelling promotional tactics. The dynamic integration allows the system to make real-time adjustments to AI outputs based on environmental and user-specific factors, optimizing the interaction and ensuring the content remains contextually relevant.

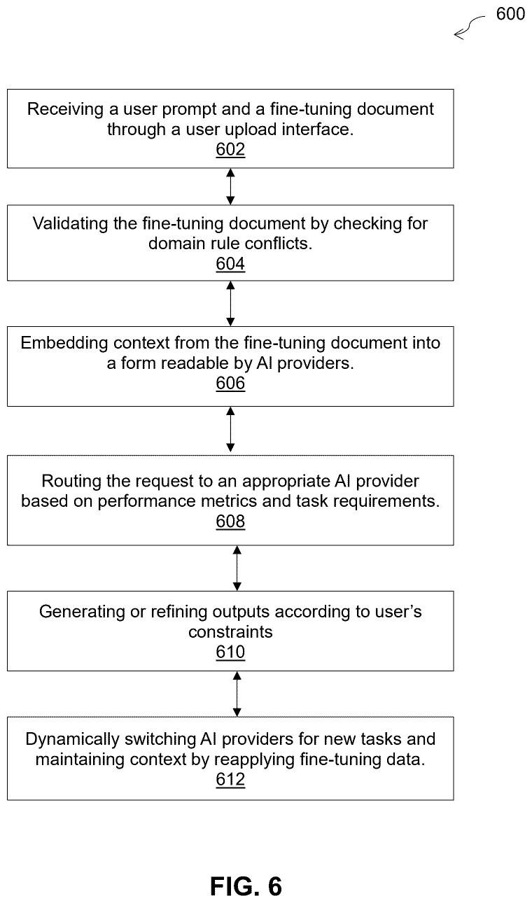

In another embodiment of the present invention, the invention discloses an orchestration system to perform a method of adaptive AI orchestration 600 as shown by FIG. 6. In the embodiment, the step 602 discloses a system that receives a user prompt and a fine-tuning document through a user upload interface. The user provides not only their request but also a comprehensive Fine-Tuning Document which may include brand guidelines, regulatory compliance details, domain-specific knowledge and personal style preferences. The document ensures that the AI models generate outputs that align with specific constraints such as company branding or legal requirements. In the embodiment, according to step 604, after receiving the document, the system validates the fine-tuning document by checking for domain rule conflicts. The step ensures that the document is free from errors or conflicts with existing domain-specific rules. For example, the system might check for any contradictions between brand guidelines and regulatory requirements to ensure the context is valid and compatible with the AI's processing capabilities. In addition, according to step 606, once the document is validated the system proceeds to embed context from the fine-tuning document into a form readable by AI providers. In the step, the system converts the fine-tuning data into a format that AI models can understand such as tokens or key-value pairs. This enables AI providers to leverage the embedded context to produce accurate and tailored outputs according to the user's specifications. Further, according to step 608, the system routes the request to the appropriate AI provider based on performance metrics and task requirements. The orchestration layer evaluates the sub-task at hand and selects the best AI model suited to the specific task. The decision is based on various factors such as the complexity of the request, the performance metrics of available AI models and the parameters provided in the fine-tuning document. In the embodiment, according to step 610, once the request has been routed to the appropriate provider the system moves to the generation or refinement of output according to the user's constraints. Further, the selected AI provider utilizes the fine-tuning data to generate or refine the output, ensuring that it adheres to the specified context. This ensures that outputs whether they involve marketing copy, technical documentation, or other content comply with the brand's voice, tone and regulatory requirements. In the embodiment, according to step 612, the system is capable of dynamically switching AI providers for new tasks while maintaining context. If additional tasks arise or the initial AI model becomes less optimal for subsequent tasks, the orchestration system can switch to another AI provider better suited to the new requirements. Additionally, the fine-tuning data is reapplied to ensure continuity and consistency across tasks, preserving the context and ensuring that the output remains aligned with the user's constraints.

In one of the embodiments of the present invention, the method further comprises encrypting all data at rest using industry-standard encryption algorithms to ensure confidentiality.

In one of the embodiments of the present invention, the instructions cause the system to automatically generate condensed summaries from large fine-tuning documents thus, selecting only relevant sections for each sub-task based on sub-task domain parameters.

In one of the embodiments of the present invention, the system utilizes block chain-based audit logging, storing records of each AI provider invocation and sub-task result in a tamper-evident ledger.

In one of the embodiments of the present invention, the system enables real-time user overrides of AI outputs, incorporating natural intelligence inputs to refine or correct results before final compilation.

In one of the embodiments of present invention, the invention includes a robust security framework for the Adaptive Hybrid AI+NI Orchestration System that ensure the confidentiality and protection of user prompts, Fine-Tuning Documents and associated data. This is achieved through encryption at rest using industry-standard encryption algorithms (e.g., AES-256) and in transit using Secure channels (e.g., TLS/SSL) that protect data flows between user interfaces, orchestration layers and AI providers. In addition, granular access control includes role-based permissions, multi-factor authentication and audit trails. The system also ensures regulatory compliance by automatically scanning for sensitive data, embedding industry-specific protocols and enforcing data residency constraints. Additionally, continuous monitoring is provided through intrusion detection systems and a formal incident response plan ensures real-time security and rapid issue resolution making the system suitable for mission-critical and regulated applications.

In one of the embodiments of the present invention, the invention includes several innovative features that enhance the flexibility, cost-effectiveness and transparency of the adaptive hybrid AI+NI orchestration system. The system include a cost optimization engine that balances cost and accuracy, dynamically adjusting resource allocation and routing tasks to more economical providers when necessary. The system also offers automated summarization of fine-tuning documents, parsing and summarizing large knowledge bases to provide relevant information based on user prompts or domain context. In addition, real-time gamified feedback allows users to rate AI outputs with rewards for high-quality feedback, improving model performance over time. Additionally, blockchain-based audit logging ensures transparent immutable records of all actions, offering tamper-evident audit trails and enhancing compliance and accountability.

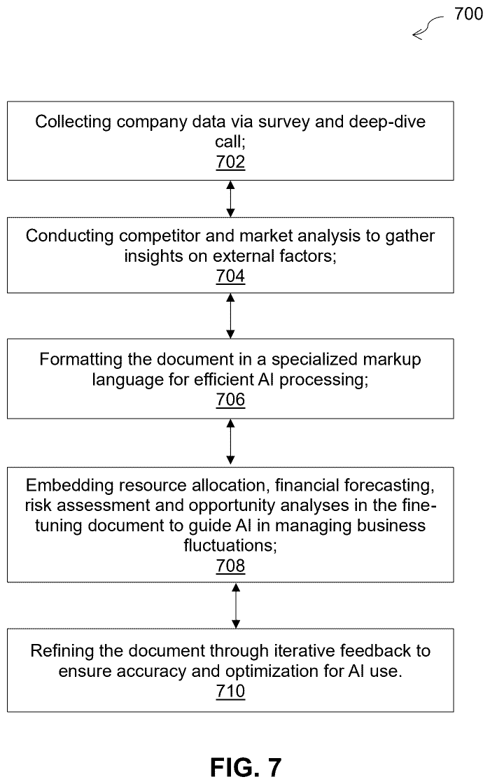

In an exemplary embodiment of the present invention, the invention discloses a method 700 for creating a Fine-Tuning Document for adaptive hybrid AI+NI orchestration as shown in FIG. 7. The method 700 involves collecting, organizing and refining essential business-specific data to ensure that AI models have accurate and context-aware information to deliver high-quality, consistent and on-brand outputs. In the embodiment, according to step 702, the method discloses collection of company data via a detailed survey and deep-dive call. The data includes the company's history, mission, vision, target audience, and workflows, which collectively form the foundation of the Fine-Tuning Document. The Fine-Tuning Documents may be gathered using a survey, an interview, or any another combination of NI inputs and that the Fine-Tuning Documents may just be text or computer code and is not an “actual document. Further, Fine-Tuning Documents may use a specialized markup language (or natural language) along with other elements. In addition, the business-specific information such as products, services and customer profiles is also collected, ensuring that the AI can better understand the company's operations and deliver more personalized responses. In the embodiment, the step 704 discloses the research and analysis phase ensuring that the AI can take into account external factors such as market trends and competitor strategies. Competitor and market analysis are conducted to gather insights on industry conditions, competitive positioning and external market influences. The analyses allow the AI to understand broader market dynamics and provide more relevant strategic suggestions, rather than just generic responses. This ensures that the AI is well-equipped to assist with decision-making in a competitive and evolving marketplace. In addition, according to step 706, once the company data and external market insights are gathered, the Fine-Tuning document is formatted using a specialized markup language which is optimized for efficient processing by large language models (LLMs). The formatting enables the document to be parsed quickly and accurately by the AI, ensuring that the AI can retrieve and use company-specific details without delays or errors. The specialized format ensures that the business data is structured in a way that allows for rapid access and manipulation, thereby improving AI response times and the overall user experience. In the embodiment, according to step 708, the method includes operational and strategic moulding into the fine-tuning document. This includes sections i.e. resource allocation, financial forecasting and risk assessment. The sections provide practical guardrails that help guide the AI in making business decisions. Additionally, challenge and opportunity analyses are embedded to prepare the AI for handling fluctuations in business and market conditions. Tools such as SWOT analysis and Porter's Five Forces are used to identify key challenges and opportunities, allowing the AI to anticipate and respond to changes in the business or market environment. Further, the step 710 discloses refinement of the fine-tuning document to ensure that the document is continuously improved and optimized. After the initial draft is created, feedback from stakeholders is integrated ensuring that the document accurately represents the company's unique needs and operational structure. The iterative feedback loop ensures that the AI understanding remains up-to-date and aligned with the company's evolving goals, products, and strategies.

In one of the embodiments of the present invention, the Fine-Tuning Document is a structured resource configured to give AI models the company-specific context. The document includes company insights (i.e. company history, mission, vision, and values), customer profiles (i.e. audience demographics and behaviors), internal processes (i.e. operational workflows, policies, best practices), products and services (i.e. details about offerings and unique selling propositions), common queries & FAQs (i.e. standardized answers for consistency), analytical frameworks (i.e. tools like SWOT and Porter's Five Forces for strategic analysis), financial planning (i.e. key metrics, costs, risks and assumptions) and competitive landscape (i.e. insights on competitors, market trends and conditions).

In one of the embodiments of the present invention, the Fine-Tuning document provides several benefits that includes boosting up of AI accuracy by supplying tailored business data, ensuring more precise and relevant responses; maintaining brand consistency by integrating style guidelines, messaging and FAQs; enhancing efficiency by enabling AI to automate tasks and quickly access information; improving decision-making through the inclusion of market research, financial insights and competitor analysis for more strategic recommendations; supporting scalability by allowing easy updates as the business grows or adopts new AI models and reducing operational costs by automating routine processes and streamlining workflows.

In one of the embodiment of the present invention, the refined fine-tuning document includes a concise document having 50+ pages of business-specific data formatted in an LLM-friendly markup to provide the AI with a thorough understanding of company operations. It also includes a fine-tuning summary which is a concise 3-4 page overview that highlights the key sections for quick reference. Additionally, the document includes an operational integration plan which provides recommendations on integrating AI into daily processes i.e. from automating replies to tracking performance metrics thus, ensuring seamless adoption of AI-driven workflows.

It should be understood that the examples provided herein are intended only for purposes of illustration and any number of other implementations is also contemplated. Additionally, the referenced examples (including the described rules and/or other techniques) can be combined in any number of ways.

Although an overview of the inventive subject matter has been described with reference to specific example implementations, various modifications and changes can be made to those implementations without departing from the broader scopes of implementation of the present disclosure. Such implementation of the inventive subject matter can be referred to herein, individually or collectively, by the term “invention” merely for convenience without intending to voluntarily limit the scope of this application to any single disclosure or inventive concept if more than one is, in fact is disclosed.

The implementations illustrated herein are described in sufficient detail to enable those skilled in the art to practice the teachings disclosed. Other implementations can be used and derived therefrom, such that structural substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources or structures described herein as a single instance. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. An adaptive hybrid AI+NI orchestration system with model stacking and fine-tuning, the system comprising:
an orchestration layer configured to manage high-level decision-making for multi-provider AI model stacking;
an AI provider library configured to house multiple specialized AI services, selected by the orchestration layer based on real-time conditions;
a performance metric repository configured to continuously log and evaluate the performance of each AI provider;
a natural intelligence (NI) fine-tuning module configured to ingest natural intelligence inputs and merge them with user prompts to generate personalized AI outputs;
a security and compliance module configured to enforce encryption, access controls and compliance logging for secure handling of user prompts, fine-tuning documents and AI outputs;
wherein the system enables real-time customization by uploading a fine-tuning document with each prompt to ensure compliance with user needs and dynamically adapts AI service selection and data processing based on real-time data and sensor data.

2. The adaptive hybrid AI+NI orchestration system as claimed in claim 1, wherein the orchestration layer continuously updates the performance metric repository based on user feedback or ratings provided after each sub-task is completed, thereby refining future AI provider selection.

3. The adaptive hybrid AI+NI orchestration system as claimed in claim 1, wherein a sensor interface is connected to the orchestration layer to receive real-time data including environmental, biometric and operational data, enabling the orchestration layer to adjust AI outputs accordingly.

4. The adaptive hybrid AI+NI orchestration system as claimed in claim 1, wherein the NI fine-tuning module is automatically summarize or extract relevant portions of the fine-tuning document based on the context of the user prompt, thereby minimizing data overload for each AI provider.

5. The adaptive hybrid AI+NI orchestration system as claimed in claim 1, wherein the orchestration layer performs mid-workflow switching from a first AI provider to a second AI provider based on conditions such as task change, cost optimization threshold, user preference for a specific AI model or latency threshold.

6. The adaptive hybrid AI+NI orchestration system as claimed in claim 1, wherein the security and compliance module include encryption at rest and in transit using an industry-standard cryptographic algorithm, role-based access controls for limiting editing of fine-tuning document and audit logging for regulatory compliance.

7. The adaptive hybrid AI+NI orchestration system as claimed in claim 1, wherein the system includes a cost optimization engine configured to compare AI provider costs with sub-task accuracy requirements and automatically switch to a more cost-effective provider when criticality falls below a threshold.

8. The adaptive hybrid AI+NI orchestration system as claimed in claim 1, wherein the AI provider library houses a variety of specialized AI services including ChatGPT, Anthropic, Gemini, Flux etc.

9. The adaptive hybrid AI+NI orchestration system as claimed in claim 1, wherein the system integrates real-time sensor data from physical or virtual sensors such as IoT devices, biometric wearables or environmental monitors to adapt AI-generated outputs based on environmental conditions, user behaviour or physiological responses.

10. The adaptive hybrid AI+NI orchestration system as claimed in claim 1, wherein the natural intelligence inputs include brand guidelines, style preferences, domain constraints and sensor data.

11. An adaptive hybrid AI+NI orchestration method with model stacking and fine-tuning, the method comprising:
receiving a user prompt by an orchestration layer that includes a request requiring the decomposition of the task into multiple sub-tasks;
decomposing the user prompt into multiple sub-tasks based on domain-specific or task-specific criteria;
accessing a performance metric repository through the orchestration layer by storing metrics for each AI provider;
selecting an AI provider for each sub-task from a plurality of AI providers based on the performance metrics and task requirements;
receiving a fine-tuning document uploaded by a user which encodes brand guidelines, stylistic preferences, compliance requirements or proprietary knowledge;
applying the fine-tuning document to the selected AI provider;
executing each sub-task to generate an output consistent with the fine-tuning document;
delivering the integrated result by combining the outputs from each subtask.

12. The adaptive hybrid AI+NI orchestration method as clamed in claim 11, wherein the fine-tuning document includes sensor data from IoT devices or wearables that influence the context in which each AI provider performs the sub-tasks.

13. The adaptive hybrid AI+NI orchestration method as clamed in claim 11, wherein compliance rules embedded within the fine-tuning document are used to filter or mask sensitive user data before transmission to selected AI providers, thereby ensuring regulatory adherence.

14. The adaptive hybrid AI+NI orchestration method as claimed in claim 11, wherein the performance metrics for each AI provider include at least one of cost, response time, output quality or user feedback ratings.

15. The adaptive hybrid AI+NI orchestration method as claimed in claim 11, wherein the method further comprises collection of user feedback after executing a sub-task, updating the performance metrics and reselecting an AI provider for subsequent sub-tasks based on the updated metrics.

16. A non-transitory computer-readable medium storing instructions that when executed by one or more processors, cause an orchestration system to perform a method of adaptive AI orchestration, the method comprising the steps of:
receiving a user prompt and a fine-tuning document through a user upload interface;
validating the fine-tuning document by checking for domain rule conflicts;
embedding context from the fine-tuning document into a form readable by AI providers;
routing the request to an appropriate AI provider based on performance metrics and task requirements;
generating or refining output according to the user's constraints; and
dynamically switching AI providers for new tasks and maintaining context by reapplying fine-tuning data.

17. The non-transitory computer-readable medium of claim 16, wherein the method further comprises encrypting all data at rest using industry-standard encryption algorithms to ensure confidentiality.

18. The non-transitory computer-readable medium of claim 16, wherein the instructions cause the system to automatically generate condensed summaries from large fine-tuning documents thus, selecting only relevant sections for each sub-task based on sub-task domain parameters.

19. The non-transitory computer-readable medium of claim 16, wherein the system utilizes block chain-based audit logging, storing records of each AI provider invocation and sub-task result in a tamper-evident ledger.

20. The non-transitory computer-readable medium of claim 16, wherein the system enables real-time user overrides of AI outputs, incorporating natural intelligence inputs to refine or correct results before final compilation.

21. A method of creation of a fine-tuning document for adaptive hybrid AI+I orchestration, the method comprising:
collecting company data including history, workflows and target audience via survey and deep-dive call;
conducting competitor and market analysis to gather insights on external factors;
formatting the document in a specialized markup language for efficient AI processing;
embedding resource allocation, financial forecasting, risk assessment and opportunity analyses in the fine-tuning document to guide AI in managing business fluctuations;
refining the document through iterative feedback to ensure accuracy and optimization for AI use.

22. The method of creation of fine-tuning document as claimed in claim 21, wherein the company data includes business-specific information such as products, services, customer profiles and internal processes.

23. The method of creation of fine-tuning document as claimed in claim 21, wherein the specialized markup language is configured to facilitate fast retrieval and processing of the company's business data using large language models (LLMs).

24. The method of creation of fine-tuning document as claimed in claim 21, wherein conducting competitor and market analysis includes analysing market trends, competitor strategies and external market conditions to provide insights for AI training.

25. The method of creation of fine-tuning document as claimed in claim 21, wherein embedding challenge and opportunity analyses involves preparing the AI to manage fluctuations in business and market conditions through tools like SWOT and Porter's Five Forces.
